(19) United States
(12) Patent Application Publication
(10) Pub. No.: US 2017/0344969 A1
(43) Pub. Date: Nov. 30, 2017

(54) Unattended Storefront Apparatus

(71) Applicant: Wal-Mart Stores, Inc., Bentonville, AR (US)

(72) Inventors: Donald R. High, Noel, MO (US); Michael D. Atchley, Springdale, AR (US)

(21) Appl. No.: 15/588,338

(22) Filed: May 5, 2017

Related U.S. Application Data
(60) Provisional application No. 62/343,275, filed on May 31, 2016.

(51) Int. Cl. G06Q 20/18; G06Q 10/08

(52) U.S. Cl. CPC G06Q 20/18; G06Q 10/087

(57) ABSTRACT

An unattended retail storefront that is installed in a consumer's residence. The unattended retail storefront includes an unsold product display and storage area, a retail-access portal that provides selective access from within the consumer's residence to the unsold product display and storage area to thereby provide a consumer in the consumer's residence with physical shopping access to the unsold product display and storage area, and an inventory-loading portal that provides selective access from outside the consumer's residence to the unsold product display and storage area, to thereby provide a retail enterprise with inventory-maintenance access to the unsold product display and storage area. Part or all of the unsold product display in storage area may be refrigerated. One or both of the aforementioned portals may be lockable as desired. By one approach the retail-access portal can be configured to automatically lock when the inventory-loading portal is opened.

### CROSS-REFERENCE TO RELATED APPLICATION

This application claims the benefit of U.S. Provisional Application No. 62/343,275, filed May 31, 2016, which is incorporated herein by reference in its entirety.

### TECHNICAL FIELD

These teachings relate generally to retail storefronts.

### BACKGROUND

Traditionally, a retail storefront is the side of a physical retail store that faces a point of pedestrian access (such as a sidewalk, street, mall pathway, and so forth) and may (or may not) have one or more windows to offer potential customers a (possibly organized) view of one or more products that are available for retail sale at the store. As used herein it will be understood that a retail storefront is not a mere facade but in fact offers a customer physical access to products being offered for retail sale within the store.

Though a successful shopping paradigm for millennia, many consumers are preferring delivery services that avoid a need to physically visit a retail store. Unfortunately, using a delivery service inherently necessitates some delay between initiating the retail transaction and taking delivery of the product being purchased. This delay may be days or even weeks in some cases. Some retailers are striving to reduce that delay to only a few hours, but even that amount of delay may be unacceptable to some consumers at least some of the time.

### BRIEF DESCRIPTION OF THE DRAWINGS

The above needs are at least partially met through provision of the unattended storefront apparatus described in the following detailed description, particularly when studied in conjunction with the drawings, wherein:

FIG. 1 comprises a block diagram as configured in accordance with various embodiments of these teachings; and

FIG. 2 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments provide for an unattended retail storefront that is installed in a consumer's residence. The unattended retail storefront includes an unsold product display and storage area, a retail-access portal that provides selective access from within the consumer's residence to the unsold product display and storage area to thereby provide a consumer in the consumer's residence with physical shopping access to the unsold product display and storage area, and an inventory-loading portal that provides selective access from outside the consumer's residence to the unsold product display and storage area, to thereby provide a retail enterprise with inventory-maintenance access to the unsold product display and storage area. Part or all of the unsold product display in storage area may be refrigerated.

One or both of the aforementioned portals may be lockable as desired. By one approach the retail-access portal can be configured to automatically lock when the inventory-loading portal is opened.

By one approach the unsold product display and storage area includes at least one sensor configured to detect product presence. A corresponding control circuit that operably couples to this sensor can be configured to detect when a consumer has removed a particular product from the unsold product display and storage area and responsively conduct a retail sale of that particular product. Similarly, the control circuit may be configured to effect a return when a consumer properly returns the particular product back to the unsold product display and storage area.

By one approach the unsold product display and storage area is stocked with a variety of unsold products that are selected based at least in part on previous purchases by a consumer who is associated with the consumer's residence. These may comprise any one of purchases made from the unattended retail storefront itself, purchases made at a manned physical retail shopping facility, and purchases made via an online purchasing opportunity.

So configured, products can be conveniently located in a consumer's home notwithstanding that the consumer did not order those products and has not yet paid for such products (and, in fact, may not ever purchase those products). Using this approach one or more products can be readily immediately purchased and be immediately available for possession and use without incurring or experiencing a delivery delay. These teachings will accommodate stocking the unattended retail storefront with products that the consumer has previously purchased and/or with one or more products that were not previously purchased by this consumer but which the consumer may likely appreciate and nevertheless purchase.

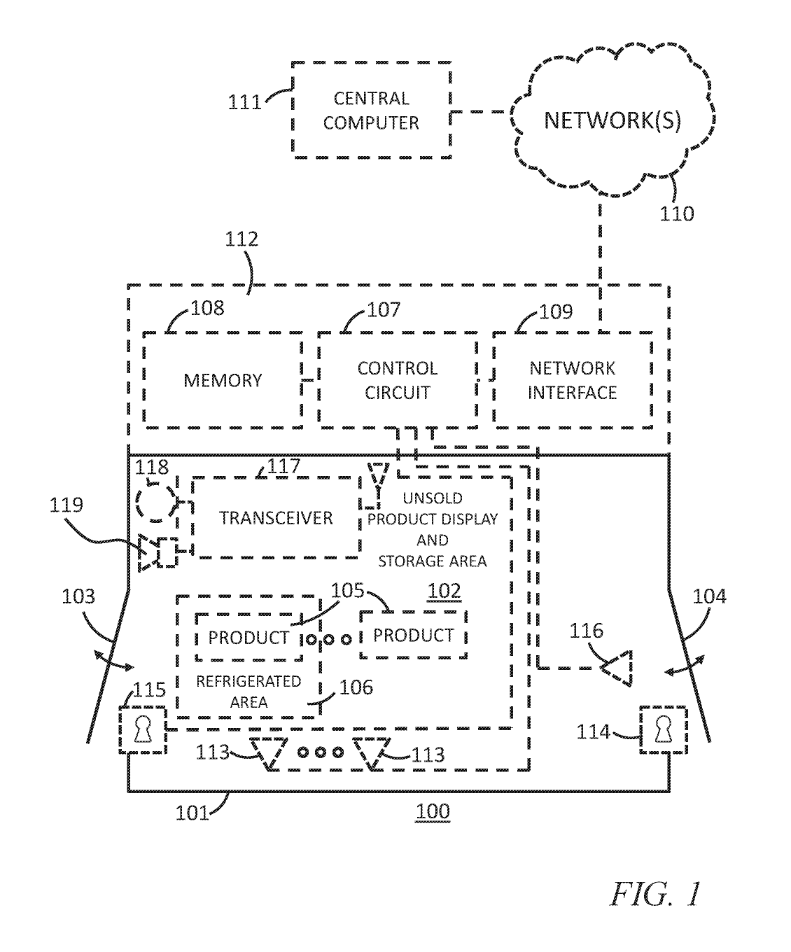

These and other benefits may become clearer upon making a thorough review and study of the following detailed description. FIG. 1 presents an illustrative example in these regards.

FIG. 1 presents an unattended retail storefront 100. As used herein, the expression “unattended” means that a customer can peruse the products that are available for retail sale and the customer can purchase and remove a particular product without any human assistance or in-person, on-site attendance on the part of the retailer. Also, in addition to a traditional retail storefront, the expression “retail storefront” as used in this technical description and in the claims shall further be understood to include other parts of the store that lie behind the traditional storefront.

The unattended retail storefront 100 includes a housing 101. This housing 101 can have essentially any form factor that may be convenient or otherwise appropriate to the application setting. In this illustrative example, and without intending any particular limitations in these regards, the housing 101 comprises a hexahedron and, in particular, a rectangular cuboid. The housing 101 and be comprised of any desired material, keeping in mind that securing its contents will typically dictate using relatively strong materials and sturdy manufacturing techniques.

The housing 101 at least includes an unsold product display and storage area 102 that can be stocked with a variety of unsold products 105. These products 105 can all be the same or can comprise a mix of different products as desired. By one approach at least one area of the unsold product display and storage area 102 comprises a refrigerated area 106. This refrigerated area 106 can serve to maintain perishable items at a non-freezing refrigerated temperature (such as near but above 32° F.) or at a frozen temperature (such as below 32° F.) as appropriate to the application setting.

The housing 101 includes a retail-access portal 103 that provides selective physical access from within a consumer's residence to the unsold product display and storage area 102 (as illustrated below in more detail). So configured this retail-access portal 103 is configured to provide a consumer in the consumer's residence with physical shopping access to the unsold product display and storage area 102. By one approach this retail-access portal 103 comprises at least one door that pivots, slides, or otherwise moves in order to provide access to the unsold product display and storage area 102 via a corresponding opening through the housing 101. Multiple such doors can be provided as desired for ease of access or, for example, to provide access to refrigerated and non-refrigerated area, respectively.

By one approach the retail-access portal comprises a non-lockable portal. In this case, though the door can be closed to thereby obstruct access to the unsold product display and storage area 102, and may possibly be retained in a closed position by, for example, a latching mechanism, the consumer is not prevented from opening the door. If desired, a locking mechanism can be provided that is usable by the consumer to control entry from within the residence to the unsold product display and storage area 102.

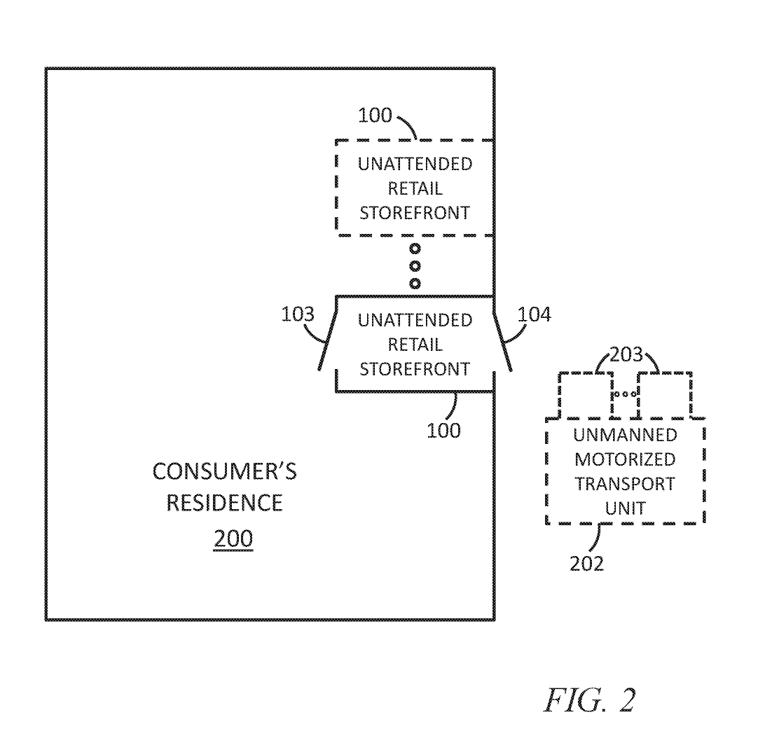

In this illustrative example, the housing 100 also has an inventory-loading portal 104. This inventory-loading portal 104 is physically distinct and separate from the aforementioned retail-access portal 103. With momentary reference to FIG. 2, this inventory-loading portal 104 therefore provides selective access from outside the consumer's residence 200 to the unsold product display and storage area 102 and therefore provides a retail enterprise (directly or through a surrogate such as an authorized delivery service) with inventory-maintenance access to the unsold product display and storage area 102.

Referring again to FIG. 1, in this illustrative example the inventory-loading portal is disposed opposite the retail-access portal 103. It will be understood that other orientations are possible. It will also be understood that the unattended retail storefront 100 can include two or more inventory-loading portals 104 as desired. Different inventory-loading portals 104 can, for example, serve to provide convenient access to different areas of the unsold product display and storage area 102 including refrigerated and non-refrigerated areas.

The inventory-loading portal 104 can also comprise a pivoting or sliding door of choice that serves to selectively obstruct access to the unsold product display and storage area 102 from outside the consumer's residence. Generally speaking, it will typically be beneficial for the inventory-loading portal 104 to comprise a lockable portal. In this example the inventory-loading portal 104 includes a locking mechanism 114 that can selectively lock the inventory-loading portal 104 in a closed position. This locking mechanism 114 is configured to be unlocked by an authorized representative of the retail enterprise to which the unattended retail storefront 100 corresponds. Various locking mechanisms are known in the art including key-operated locking mechanisms as well as locking mechanisms that respond to entry codes that are manually entered, locking mechanisms that respond to a wirelessly-transmitted code, and so forth. As the present teachings are not particularly sensitive to any particular choices in these regards, further elaboration here in these regards is avoided for the sake of brevity.

In this particular example, the unattended retail storefront 100 includes a control circuit 107. Being a “circuit,” the control circuit 107 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 107 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 107 is configured (for example, by using corresponding programming as will be well understood by those skilled in the art) to carry out one or more of the steps, actions, and/or functions described herein.

By one optional approach the control circuit 107 operably couples to a memory 108. This memory 108 may be integral to the control circuit 107 or can be physically discrete (in whole or in part) from the control circuit 107 as desired. This memory 108 can also be local with respect to the control circuit 107 (where, for example, both share a common circuit board, chassis, power supply, and/or housing) or can be partially or wholly remote with respect to the control circuit 107 (where, for example, the memory 108 is physically located in another facility, metropolitan area, or even country as compared to the control circuit 107).

This memory 108 can serve, for example, to non-transitorily store the computer instructions that, when executed by the control circuit 107, cause the control circuit 107 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 107 also operably couples to a network interface 109. So configured the control circuit 107 can communicate with other elements (both within the unattended retail storefront 100 and external thereto) through one or more intervening networks 110 via the network interface 109. As one particularly salient example the network interface 109 can serve to couple the control circuit 107 to a remotely-located central computer 111 that is operated (either directly or indirectly) by an enterprise that also operates the unattended retail storefront 100. Network interfaces, including both wireless and non-wireless platforms, are well understood in the art and require no particular elaboration here.

By one optional approach the unattended retail storefront 100 includes one or more sensors 113 that are configured to detect product presence. Examples in these regards include but are not limited to weight sensors, ultrasonic transponders, camera-based components, radio-frequency identification (RFID)-tag readers, and so forth. Such sensors 113 can be located, for example, at least partially within the unsold product display and storage area 102 or otherwise as desired.

So configured, and presuming that these sensors 113 are directly or indirectly coupled to the control circuit 107, the control circuit can detect when a consumer removes a particular product 105 from the unsold product display and storage area 102 and responsively conduct a corresponding retail sale of that particular product 105 to the consumer. Similarly, the control circuit 170 can detect when a consumer properly returns a particular product 105 back to the unsold product display and storage area 102 (for example, after having removed the product from the unsold product display and storage area 102 to physically examine the product and having returned the product to the unsold product display and storage area 102 within a predetermined time (such as, for example, 30 seconds, one minute, five minutes, or other duration of choice) upon having decided to not purchase the product at this time and responsively conduct a corresponding return (i.e., refund) with respect to the returned product 105.

By another optional approach the unattended retail storefront 100 can include a sensor 116 configured to detect when the inventory-loading portal 104 is open. Any number of sensor methodologies can serve in these regards. By operably coupling such sensor(s) 116 to the control circuit 107, and presuming that a selectively controllable lock mechanism 115 is available at the retail-access portal 103, the control circuit 107 can be configured to automatically lock the retail-access portal 103 when the inventory-loading portal 104 is open.

Conversely, the control circuit 107 can be configured to unlock the retail-access portal lock mechanism 115 so long as the inventory-loading portal 104 is closed. So configured, both a delivery person properly accessing the unattended retail storefront 100 via the inventory-loading portal 104 as well as an unauthorized person who gains unauthorized access via the inventory-loading portal 104 are prevented from entering the consumer's residence or even seeing into the consumer's residence through the unsold product display and storage area 102.

With continued reference to FIG. 1, these teachings will also accommodate supporting voice communications between a consumer at the unattended retail storefront 100 and a representative for the unattended retail storefront 100. In this particular example, the unattended retail storefront 100 includes a two-way wireless transceiver 117 (employing, for example, cellular telephony, Wi-Fi, or some other wireless or non-wireless communications modality of choice) having a microphone 118 and a speaker 119. So configured, a consumer present at the unattended retail storefront 100 can both speak with and listen to one or more other parties such as the aforementioned representative for the enterprise hosting the unattended retail storefront 100.

As noted above, the unsold product display in storage area 102 contains unsold products 105. The particular products 105 used to stock the unattended retail storefront 100 can be determined using one or more approaches. As one simple example in these regards, the consumer can provide responses to inquiries in these regards designed to elicit choices and preferences for what products should be stocked in the unattended retail storefront 100.

By another approach, in lieu of the foregoing or in combination therewith, one or more of the unsold products 105 can be selected based at least in part on previous purchases by a consumer who is associated with this residence (or, of course, multiple consumers, such as various family members, who reside at this particular location). For example, the previous purchases may include purchases made at a manned, physical retail shopping facility (such as, for example, a retail shopping facility that is owned and/or operated by the enterprise that controls the unattended retail storefront 100).

As another example, in combination with the foregoing or otherwise, the aforementioned previous purchases can include online purchases. Such online purchases may have been through an enterprise that again comprises the enterprise that owns and/or operates the unattended retail storefront 100. And as yet another example, and again in combination with the foregoing or otherwise, the aforementioned previous purchases can include previous purchases made from the unattended retail storefront 100 itself.

Referring again to FIG. 2, these teachings will accommodate installing a plurality of unattended retail storefront 100 at a single consumer's residence 200. Such a plurality of unattended retail storefronts 100 can be physically positioned adjacent or nearly adjacent to one another, or can be located further apart as desired. For example, it may be useful to provide one unattended retail storefront 100 in one room of the consumer's residence 200 and another unattended retail storefront 100 in another, different room of the consumer's residence 200. When providing multiple unattended retail storefronts 100, these teachings will readily accommodate stocking the different unattended retail storefronts 100 with partially or wholly differing products as desired.

The unattended retail storefront 100 can be stocked by an appropriate associate or agent of the enterprise that owns and/or operates the unattended retail storefront 100. These teachings will also accommodate, if desired, including an unmanned motorized transport unit 202 configured to carry unsold products 203 to the unattended retail storefront 100 and convey the unsold products 203 to the unsold product display and storage area 102 via the inventory-loading portal 104. If desired, this unmanned motorized transport unit 202 can be further configured to remove unsold (or returned) products from the unsold product display and storage area 102 via the inventory-loading portal 104. The unmanned motorized transport unit 202 can comprise, for example, a terrestrial or airborne drone configured to properly interact with the unattended retail storefront 100 in these regards.

So configured, a consumer can have ready access to a variety of products without leaving their home and with effectively no delay between purchasing and taking possession of a particular product. Assuming appropriate stocking of the unattended retail storefront 100, these teachings can greatly improve the consumer experience to a point where “shopping” is very nearly a completely transparent process that requires almost no shopping or delivery time in and of itself.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
an unattended retail storefront installed in a consumer's residence, the unattended retail storefront comprising:
an unsold product display and storage area;
a retail-access portal that provides selective access from the consumer's residence to the unsold product display and storage area configured to provide a consumer in the consumer's residence with shopping access to the unsold product display and storage area;
an inventory-loading portal that provides selective access from outside the consumer's residence to the unsold product display and storage area configured to provide a retail enterprise with inventory-maintenance access to the unsold product display and storage area.

2. The apparatus of claim 1 wherein the unsold product display and storage area includes at least one area that is refrigerated.

3. The apparatus of claim 1 wherein the retail-access portal comprises a non-lockable portal.

4. The apparatus of claim 3 wherein the inventory-loading portal comprises a lockable portal.

5. The apparatus of claim 1 wherein the retail-access portal is configured to automatically lock when the inventory-loading portal is open.

6. The apparatus of claim 1 wherein the unsold product display and storage area includes at least one sensor configured to detect product presence.

7. The apparatus of claim 6 further comprising:
a control circuit operably coupled to the at least one sensor and configured to detect when a consumer has removed a particular product from the unsold product display and storage area.

8. The apparatus of claim 7 wherein the control circuit is further configured to conduct a retail sale of the particular product to a consumer in response to detecting removal of the particular product from the unsold product display and storage area.

9. The apparatus of claim 8 wherein the control circuit is further configured to effect a return when a consumer properly returns the particular product back to the unsold product display and storage area.

10. The apparatus of claim 1 further comprising:
an unmanned motorized transport unit configured to carry unsold products to the unattended retail storefront and convey the unsold products to the unsold product display and storage area via the inventory-loading portal.

11. The apparatus of claim 10 wherein the unmanned motorized transport unit is further configured to remove unsold products from the unsold product display and storage area via the inventory-loading portal.

12. The apparatus of claim 1 further comprising:
a network interface configured to communicatively couple the unattended retail storefront to a remotely-located central computer that is operated by an enterprise that also operates the unattended retail storefront.

13. The apparatus of claim 1 further comprising:
a network interface configured to provide voice communications between a consumer at the unattended retail storefront and a representative for the unattended retail storefront.

14. The apparatus of claim 1 further comprising a plurality of the unattended retail storefronts that are all installed in the consumer's residence.

15. The apparatus of claim 1 wherein the unsold product display and storage area is stocked with a variety of unsold products.

16. The apparatus of claim 15 wherein the variety of unsold products are selected based at least in part on pervious purchases by a consumer who is associated with the consumer's residence.

17. The apparatus of claim 16 wherein the previous purchases includes purchases made from the unattended retail storefront.

18. The apparatus of claim 16 wherein the previous purchases include purchases made at a manned retail shopping facility.

19. The apparatus of claim 16 wherein the previous purchases include online purchases.

20. The apparatus of claim 16 wherein the previous purchases includes purchases made from the unattended retail storefront, purchases made at a manned retail shopping facility, and purchases made online.
